(19) United States
(12) Patent Application Publication
(10) Pub. No.: US 2023/0011095 A1
(43) Pub. Date: Jan. 12, 2023

(54) AUTHENTICATION SYSTEM

(71) Applicant: Hewlett-Packard Development Company, L.P., Spring, TX (US)

(72) Inventors: Adrian John Baldwin, Bristol (GB); Thalia May Laing, Bristol (GB); Katherine Wilson, Bristol (GB); Roberto Jordaney, Bristol (GB)

(73) Assignee: Hewlett-Packard Development Company, L.P., Spring, TX (US)

(21) Appl. No.: 17/783,166

(22) PCT Filed: Jan. 15, 2020
(86) PCT No.: PCT/US2020/013653

§ 371 Date: Jun. 7, 2022

(51) Int. Cl. H04L 9/40

(52) U.S. Cl. CPC H04L 63/20; H04L 63/0861; H04L 63/083

(57) ABSTRACT

In an example there is provided a method for initiating an auxiliary access protocol in an authentication session. The method comprises providing attestation data attesting to a cause of an outcome of an authentication attempt in an authentication session, accessing a policy to initiate an auxiliary access protocol, determining if the attestation data fulfils a criterion according to the policy and initiating the auxiliary access protocol on the basis of said determination.

### BACKGROUND

Authentication systems are used to identify users prior to granting access to systems, devices, services and physical locations. A user may be prompted to demonstrate knowledge or ownership of an authentication factor, such as a device or a password, as part of an authentication process. In other systems a user may be prompted to provide biometric data. The authentication system verifies the identity of the user on the basis of the authentication factor. Legitimate users may lose the ability to authenticate due to the loss of an authentication factor.

### BRIEF DESCRIPTION OF THE DRAWINGS

FIG. 1 is a schematic diagram showing an authentication system, according to an example.

FIG. 2 is a block diagram showing a method of for initiating an auxiliary protocol, according to an example.

FIG. 3 shows a processor associated with a memory comprising instructions for initiating a secondary protocol, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Authentication systems are used to verify the identity of an entity as part of an access control mechanism. Authentication systems are used in a wide variety of different contexts. For example, in modern computing environments authentication systems are used to establish the identity of a user. The authentication system enables legitimate users to access applications, systems or data on the computing system and protects the computing system against intrusion. Authentication systems are used in payment systems to verify transactions or to verify the identities of entities involved in a transaction. Authentication systems are also found in access control systems in buildings and secure locations.

Authentication systems implement authentication protocols to verify the identity of the user. As part of such a protocol a user may be asked to demonstrate that they have an authentication factor. Some systems also combine different types of factors, or allow a user to authenticate using different authentication factors.

Authentication factors come in different forms. For example, in some systems a user may be asked to provide “something they know”, such as a password or code. In other cases the authentication factor may be “something they have” such as a token or device. A device can store a cryptographically secure password and can use public key cryptography. In other systems a user may be asked to provide “something they are” such as a biometric. For example, some systems may prompt a user to give a retina or fingerprint scan.

Authentication systems may prevent a legitimate user from authenticating themselves. This can happen due to a failure of the user to provide adequate information when prompted by the system. Alternatively, a failure of the authentication system may prevent a user from authenticating. For example, the system may experience a sensor or scanner failure.

In some examples, a failure to authenticate may be due to additional factors outside the control of either the user or the authentication system. For example, a user trying to authenticate over the internet may experience a loss of a connection during an authentication session. A user who is asked to provide a photo for a facial recognition system may be unable to authenticate due to poor lighting conditions.

Some authentication systems implement backup or failsafe systems as an alternative means of gaining access to the protected system or service. For example, online password-based authentication systems may provide account recovery via an email which is sent to an email account provided by the user.

The backup system provides a new attack vector for an attacker who wishes to subvert the authentication system. In the case of account recovery via email, for example, the attacker can target the email account instead of the password-based authentication system. In general, the security of the authentication system can be compromised by outsourcing the backup system to a possibly weaker authentication process.

The methods and systems described herein initiate an auxiliary access protocol in an authentication system. The auxiliary access protocol provides an alternative backup system for accessing a service when the primary authentication route is unavailable or a legitimate user fails to authenticate.

The methods and systems described herein may be used with any type of authentication system. Examples are described for authentication systems based on “something you know”, “something you are” or “something you have” or a combination thereof.

Herein an “auxiliary access protocol” is any protocol implemented in a system as a replacement protocol for an authentication protocol. That is, an auxiliary access protocol provides a user or device a means of gaining access to a system, location or data, collectively referred to as a “service”, when the primary access protocol via the authentication system is unavailable. An auxiliary access protocol may be configurable by e.g. an administrator to provide different levels of access to a service.

In the methods described herein, an auxiliary access protocol is initiated on the basis of evidence supplied to or retrieved by the system. The evidence provides assurances to the system that the primary authentication route is unavailable or will fail before enabling the auxiliary access protocol.

A policy mechanism is implemented to determine when the auxiliary access protocol is triggered. The policy includes notions of the types of failures that occur in the authentication system. The policy also specifies criteria for triggering the auxiliary access protocol on the basis of evidence supplied by the user. The evidence attests the cause of the failure or unavailability of the authentication system.

The policy may also specify configurations of the auxiliary access protocol. For example, the policy may be used to configure the auxiliary access protocol so that the user is allowed a greater or lesser level of access to a service on the basis of the amount or quality of evidence provided.

A policy may be user or organisation-specific. A policy may be modified to reflect the changing circumstances of a user or entity. For example, a policy may be modified to allow a user to initiate the auxiliary access protocol on the basis of weaker evidence if the user recently had a promotion to a more senior role in an organisation.

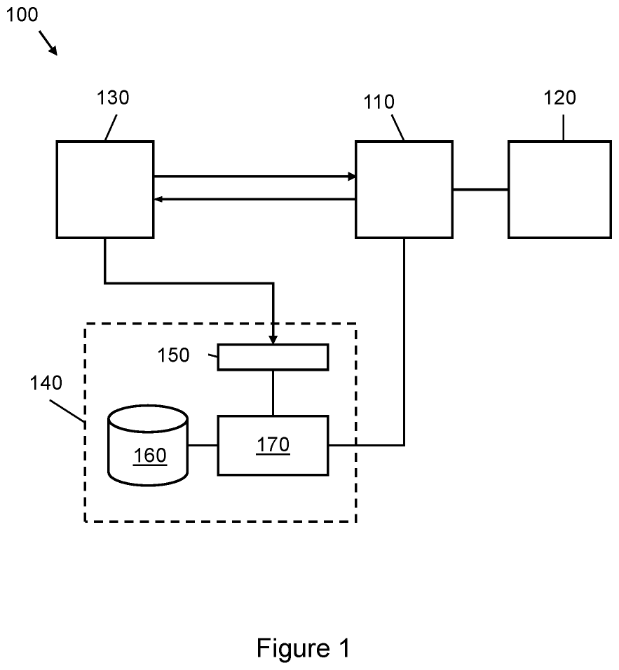

FIG. 1 shows an apparatus 100 for regulating access to a service, according to an example. The apparatus 100 shown in FIG. 1 may be used in conjunction with the methods described herein.

The apparatus 100 comprises an authentication system 110. The authentication system 110 may be a computer-based authentication system, executed in hardware or software on a computing device. In another example, the authentication system 110 is a dedicated digital circuit which implements an authentication protocol. The authentication system 110 is arranged to regulate access to a service 120. In examples, the service 120 may be a computing system, database, application or website. In other cases, the service 120 is a physical protected location.

The authentication system 110 interacts with an authenticating entity 130. The authenticating entity 130 may be a user who wishes to authenticate themselves. In some cases, the authenticating entity 130 may comprise a user device which is used to interact with the authentication system 110, such as may be the case where a user authenticates themselves using “something they have”. In another case, the authenticating entity may itself be a device which authenticates itself with the authentication system 110. For example, a server with an identity may authenticate itself with an authentication system to connect to further services.

The authenticating entity 130 participates in an authentication session with the authentication system 110. The authentication session follows an authentication protocol. If the authenticating entity 130 successfully authenticates themselves in the authentication session then the authentication system 110 is arranged to grant the authenticating entity 130 access to the service 120. If the authenticating entity 130 is unable to authenticate themselves in the authentication session then the authentication system 110 is arranged to prevent access to the service.

The authenticating entity 130 may be prompted to enter an input during an authentication session. In some authentication systems an interface for entering data is provided. For example, in the case where the authentication system 110 is a biometric authentication system, an interface may comprise a fingerprint scanner or retina scanner.

In some cases, the authenticating entity 130 communicates electronically with the authentication system 110. For example, in the case where the authenticating entity 130 is a device, the device may be arranged to communicate with the authentication system 110 over a network.

In some examples, the communication between the authenticating entity 130 and authentication system 110 is wireless communication. For example, in the case where the authenticating entity 130 is a device such as a phone, the device may be arranged to communicate with the authentication system 110 using near-field communication or Wi-Fi.

The authentication system 110 is communicatively coupled to a system 140. According to examples described herein, the system 140 is arranged to provide an auxiliary access route for the authenticating entity 130. The auxiliary access route is made available to the authenticating entity 130, when the primary access route provided for by the authentication system 110, has or will fail due to an inability of the authenticating entity 130 to authenticate themselves.

The system 140 implements an access policy mechanism. The access policy mechanism determines the conditions under which the auxiliary access route is provided to the authenticating entity 130. As part of the policy enforcement mechanism the system 140 collects data from the authenticating entity 130. The data is used as evidence of a cause of a failure or likely failure of an authentication attempt by the authenticating entity 130. The data is collected by an evidence acquisition module 150.

In FIG. 1, the evidence acquisition module 150 is communicatively coupled to the authenticating entity 130. The evidence acquisition module 150 may be arranged to receive data from one or more further entities. These entities may vouch for the authenticating entity 130, by providing evidence of a cause of a failure or likely failure of an authentication attempt by the authenticating entity 130. For example, a co-worker of a user may confirm the identity of a user by submitting data proving that they are co-workers.

The system 140 further comprises a policy database 160. The policy database 160 stores policy data specifying criteria for initiating the auxiliary access protocol. According to examples described herein, policy data may include data specifying the target service 120. The policy data also comprises a notion of “failure types”. A failure type defines a type of authentication failure for the authentication system 110. For example, if the authentication system 110 relies on a user demonstrating possession of a device, the failure type may specify that authentication will be unsuccessful when the device is lost, stolen or damaged.

The policy data further specifies one or more criterion for triggering the auxiliary access protocol. For example, in the case where the authentication system 110 asks a user to demonstrate possession of a device, the criteria may specify that the user demonstrate using e.g. location data of the last known location, that their device is lost, stolen or damaged.

The apparatus further comprises a controller 170 that is communicatively coupled to the policy database 160 and evidence acquisition module 150. The controller 170 is arranged to determine whether data received at the evidence acquisition module 150 fulfils criteria according to policy data stored by the policy database 160. The controller 170 initiates the auxiliary access protocol on the basis of the determination.

In some cases, the policy may include a threshold criterion. For example, the criterion may specify that if the battery of an authenticating device is low enough then the auxiliary access protocol may be triggered. In that case, the system 140 may be arranged to receive regular notifications of the battery status, via the evidence acquisition module 150. If the battery falls below the level specified in the criterion, then the controller 170 may determine that the auxiliary access protocol may be used in place of the authentication system 110.

In another example, where the authenticating entity is itself a device, the failure of the device may lead to inability to authenticate. For example, in the case of a server described previously, authentication keys may become unavailable following a server crash. In that case, policy data may comprise Data specifying acceptable causes and the requisite evidence to demonstrate a server crash. The system 140 may be arranged to execute an auxiliary access protocol which includes key regeneration linking back to an original endorsement certificate associated to the server. In another case, the auxiliary access protocol re-registers the server through a trusted administrator.

In other cases, the policy data may also specify criteria that determine when a user is not permitted to use the auxiliary access protocol. For example, if data acquired by the evidence acquisition module 150 shows that the authenticating entity 130 locally authenticated using a device, five minutes prior to a request to use the auxiliary access protocol, then a request to use the auxiliary access protocol may be denied by the controller 170.

In some examples, the authentication system 110 may implement a multi-device authentication protocol. For example, the authenticating entity 130 may be asked to demonstrate possession of three out of four devices to authenticate. In that case, the system 140 may implement a policy that specifies that the auxiliary access protocol is initiated if two out of four devices are present and a third device can be accounted for. For example, the user may submit evidence to the evidence acquisition module 150, such as location data, that shows that a third device is in a known location registered with the system 140.

In the case where the authentication system 110 authenticates the authenticating entity 130 on the basis of “something known”, then the policy may include criteria to seek assurances that the authenticating entity 130 is the correct user. For example, in the case of a password, the policy may include a threshold criterion relating to likelihood that a user forgot their password. The policy may also include threshold criteria relating to elapsed time since the password was set, the password complexity, how often the user has incorrectly entered their password or how accurate the incorrectly submitted password is.

For an authentication system 110 that relies on the authenticating entity 130 demonstrating ‘something they are’, such as biometric data, the policy may specify the auxiliary access protocol can be used when the biometric data is unavailable. For example, if a user is asked to input fingerprint data, then criteria may specify that the auxiliary access protocol can be initiated on the basis of medical data which demonstrates the inability to give a fingerprint.

In other examples, biometrics that are a close enough match to the correct biometric are used to trigger the auxiliary access protocol. In an example, a threshold criterion may specify that a 70% match is considered sufficiently close by the authentication system 110 and a 65% match is considered sufficiently close to initiate the auxiliary access protocol. Below a 65% match is not sufficient.

In a further example, in an authentication system 110 that uses facial recognition, a policy may include a threshold criterion for initiating the auxiliary access protocol on the basis of the quality of the lighting conditions. The authenticating entity 130 can submit data recorded from a sensor to the evidence acquisition module 150 to demonstrate that the level of light is poor and that facial recognition is impossible.

According to examples described herein, the system 140 further comprises a policy management module (not shown in FIG. 1). The policy management module is communicatively coupled to the policy database 160. The policy management module is arranged to access policy data stored in the policy database 160, to modify policy data. According to examples, modifying policy data may comprise adding policy data to an existing policy, deleting policy data, or modifying existing policy data. The modified policy is subsequently used by the controller 170 when determining whether to initiate the auxiliary access protocol.

According to an example, the system 140 may further comprise an audit module (not shown in FIG. 1) communicatively coupled to the controller 170. The audit module is arranged to generate an audit log of authentication attempts, on the basis of session data. Herein, “session data” is data which is generated or used in an authentication session. For example, session data may comprise data relating to messages that are passed between the authenticating entity 130, and authentication system 110 during an authentication session. According to examples described herein, the controller 170 may be arranged to initiate the auxiliary access protocol on the basis of the audit log.

In some cases, the authenticating entity 130 may be provided with a more restricted level of access to the service 120 compared to the level of access provided by the main authentication system 110. The level of access may be configurable by the system 140.

In some examples, the controller 170 is arranged to configure or select the auxiliary access protocol on the basis of data received at the evidence acquisition module 150. The configuration or selection of the auxiliary access protocol may be determined according to a policy stored on the policy database 160. For example, a policy may specify that the level of access granted to the authenticating entity 130 depends on the quality and amount of evidence provided. In one case, the policy may specify that the auxiliary access protocol is configured or selected to be more rigorous when data provided as evidence attesting to the cause of a failure is weaker, and more lenient when the evidence provided is stronger.

In some cases, the policy may also specify that if additional evidence is submitted by the authenticating entity 130, the controller 170 can upgrade the level of access to the service 120, by re-configuring the auxiliary access protocol.

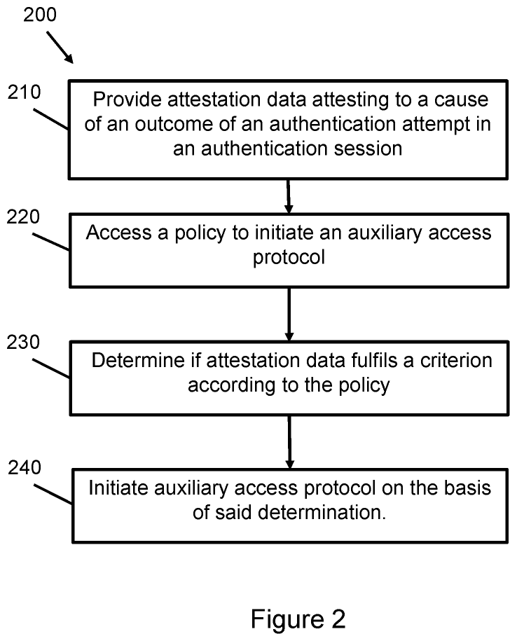

FIG. 2 is a block diagram showing a method 200 for initiating an auxiliary access protocol in an authentication session, according to an example. The method 200 is implemented for an authentication session between an authenticating entity and an authentication system. In particular, the method 200 shown in FIG. 2 may be used in conjunction with the apparatus 100 shown in FIG. 1.

At block 210 attestation data attesting to a cause of an outcome of an authentication attempt in an authentication session is provided. According to examples, the attestation data may be provided to the evidence acquisition module 150, shown in FIG. 1.

In examples, the attestation data is based on attributes of an authenticating entity participating in the authentication session. For example, in the case where the authenticating entity is a device, the attestation data may comprise location, usage or state data associated to an authenticating entity.

The attestation data may comprise data that is generated on the basis of input data from the authenticating entity, during the authentication session. The attestation data may also comprise data from a further entity associated to an authenticating entity participating in the authentication session. The further entity may be a further user device, or a device of another person associated to the user.

At block 220, a policy to initiate an auxiliary access protocol is accessed. According to examples, this may be performed by the controller 170 when the method 200 is implemented on the apparatus 100 shown in FIG. 1.

At block 230, a determination of whether the attestation data fulfils a criterion according to the policy is made. In examples, determining whether the attestation data fulfils the criteria comprises comparing the attestation data according to a threshold criterion.

At block 240, if it is determined that the criterion in the policy is satisfied, then the auxiliary access protocol is initiated on the basis of the determination. In FIG. 1, the auxiliary access protocol is initiated by the controller 170.

The method 200 may further comprise configuring the auxiliary access protocol on the basis of the attestation data. Configuring the auxiliary access protocol may comprise, increasing or decreasing access to a service on the basis of the attestation data provided by an authenticating entity.

In some examples, the method 200 comprises generating a modified policy. Subsequently, the determination of whether attestation data fulfils criteria of the policy is made on the basis of the criteria according to the modified policy. Initiation of the auxiliary access protocol is made on the basis of the determination.

The methods and systems described herein provide a more flexible and secure backup access mechanism for situations where a primary access route is unavailable to a user.

Backup mechanisms that outsource recovery to third party systems are added to authentication systems to make them more user friendly. Unfortunately, these mechanisms introduce vulnerabilities that attackers can exploit.

In contrast, the methods and systems described herein provide an alternative access route for users that can provide appropriate evidence demonstrating why an authentication session via the primary authentication system has or will fail.

The methods can be implemented in conjunction with a wide variety of authentication systems. In particular, examples are described for authentication systems based on “something you know”, “something you are” or “something you have”. The methods and systems described herein do not compromise the security of the existing authentication system as the criteria specified in the policy ensure that a minimum level of evidence is provided prior to initiating the auxiliary access protocol.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

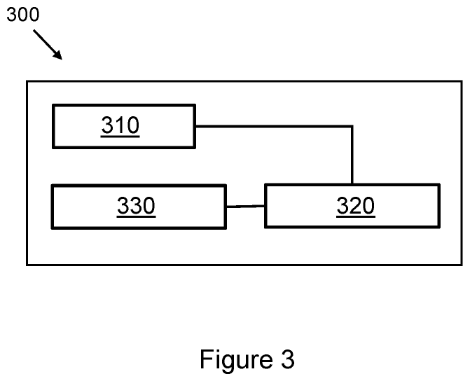

For example, the instructions may be provided on a non-transitory computer readable storage medium encoded with instructions, executable by a processor. FIG. 3 shows an example of a processor 310 associated with a memory 320. The memory 320 comprises computer readable instructions 330 which are executable by the processor 310.

The instructions 330 cause the processor to access data attesting to a cause of an outcome of an authentication attempt in an authentication protocol, access policy data to initiate a secondary access protocol, determine if the data fulfils a criterion according to the policy data and initiate the secondary access protocol on the basis of the determination.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for initiating an auxiliary access protocol in an authentication session, the method comprising:
providing attestation data attesting to a cause of an outcome of an authentication attempt in an authentication session;
accessing a policy to initiate an auxiliary access protocol;
determining if the attestation data fulfils a criterion according to the policy; and
initiating the auxiliary access protocol on the basis of said determination.

2. The method of claim 1, wherein the attestation data are based on attributes of an authenticating entity participating in the authentication session.

3. The method of claim 2, wherein the attestation data comprises location, usage and/or state data associated to the authenticating entity.

4. The method of claim 1, wherein the criterion is a threshold criterion for the attestation data for initiating the auxiliary access protocol.

5. The method of claim 1, wherein the attestation data comprises data generated on the basis of input data from the authenticating entity, during the authentication session.

6. The method of claim 5, wherein the input data comprises biometric data or password data.

7. The method of claim 1, comprising:
generating a modified policy;
determining if the attestation data fulfils criterion according to the modified policy; and
initiating the auxiliary access protocol on the basis said determination.

8. The method of claim 1, wherein providing attestation data comprises receiving data from a further entity associated to an authenticating entity participating in the authentication session.

9. The method of claim 1, comprising configuring the auxiliary access protocol on the basis of the attestation data.

10. An apparatus for an authentication system comprising:
an evidence acquisition module to receive data attesting to a cause of an outcome of an authentication attempt in an authentication session;
a policy database to store policy data specifying criteria for initiating a secondary access protocol; and
a controller communicatively coupled to the policy database and evidence acquisition module, to:
determine whether data received at the evidence acquisition module fulfils criteria according to policy data stored by the policy database; and
initiate the secondary access protocol on the basis of the determination.

11. The apparatus of claim 10, comprising a policy management module, communicatively coupled to the policy database, to modify policy data stored on the policy database.

12. The apparatus of claim 10, comprising an audit module to generate an audit log of authentication attempts, on the basis of session data generated by the authentication system.

13. The apparatus of claim 12, wherein the controller initiates the secondary access protocol on the basis of the audit log.

14. The apparatus of claim 10, wherein the controller configures the secondary access protocol on the basis of data received at the evidence acquisition module.

15. A non-transitory machine-readable storage medium encoded with instructions executable by a processor, to:
access data attesting to a cause of an outcome of an authentication attempt in an authentication protocol;
access policy data to initiate a secondary access protocol;
determine if the data fulfils a criterion according to the policy data; and
initiate the secondary access protocol on the basis of the determination.
